(19) United States
(12) Patent Application Publication
(10) Pub. No.: US 2006/0289348 A1
(43) Pub. Date: Dec. 28, 2006

(54) Centrifugal press for drying wet, respectively moist, graded product

(76) Inventor: Joachim Steinbeck, Gorisried (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 11/167,276

(22) Filed: Jun. 28, 2005

(51) Int. Cl. B01D 25/00

(52) U.S. Cl. 210/224; 100/116; 210/360.1

(57) ABSTRACT

The invention refers to centrifugal press for drying wet, respectively moist, graded product, comprising a housing provided with a filter basket, which can be set in a motion of rotation, and an outlet for the liquid leaving the graded product. The invention is characterised by the fact that a rotatably supported screw conveyor is arranged in the filter basket, and an inlet for the graded product is provided through which the graded product is conveyed between filter basket and screw conveyor to an outlet for the dried product.

The invention refers to a centrifugal press for drying wet, respectively moist, graded product, comprising a housing in which a filter basket is provided, which can be set in a motion of rotation by means of a drive, and an outlet for the liquid leaving the graded product.

### BACKGROUND OF THE INVENTION

Centrifugal presses of this type for drying wet, respectively moist, graded product are known. They work according to the principle of a spin drier. That means the graded product is loaded, like in a spin drier, in a basket-like container, and then set in a motion of rotation. Through the centrifugal process then the liquid is transported out of the centrifugal product. However, the problem occurs here that the centrifugal product remains axially with respect to the centrifugal axis, and, as known from the spin drier, actually a loading and unloading in batches would be necessary. For a continuous process this solution is, however, not suitable so that the invention has the task to suggest a drying unit which dries the moist product, respectively the graded product, in a continuous process.

### BRIEF ABSTRACT OF THE INVENTION

The invention comes from the described prior art, and suggests a centrifugal press for drying wet, respectively moist, graded product, comprising a housing in which a filter basket is provided which can be set in a motion of rotation by means of a drive, and an outlet for the liquid leaving the graded product, characterised by the fact that a rotatably supported screw conveyor is arranged in the filter basket, and an inlet for the graded product is provided through which the graded product is conveyed between the filter basket and screw conveyor to an outlet for the dried product. The liquid leaving by means of the motion of rotation of the screw conveyor on the filter basket is, of course, as usual, collected in the housing, and let off there. By means of such an arrangement now a continuous drying of the graded product is possible. The graded product is introduced moistly in the centrifugal press, pressed to the filter basket through the screw conveyor, which is supported and driven rotatably, and dried in this way. By the fact that a screw conveyor conveys the graded product in the spiral to the outlet the graded product is dried further during the conveying motion, and gets in a very convenient, dry condition to the outlet for the dried product. The liquid may, as well as the dried graded product, be collected either in containers or conducted via pipes to sewage treatment plants or to the drain. The dried graded product is collected preferably in containers or vessels, and then transported away, for example, to further utilisation.

According to an advantageous development of the invention it is provided that the drive drives the screw conveyor as well as the filter basket, preferably with different rotary frequencies. By the fact that the screw conveyor as well as the filter basket is driven, and this is carried out preferably with differing rotary frequencies, a relative movement occurs between the screw conveyor and the filter basket. By means of that a self-cleaning is at least favoured, and the openings, also called perforations, of the filter basket are prevented for the main part from clogging. This saves maintenance which costs time and thus money.

The dimension of the differences in the rotary frequencies for the filter basket and the screw conveyor is between 1% and 20%. It has turned out, according to the invention, that the best results are achieved in a range of differences in rotary frequencies between 6% and 8%.

It is convenient here if for the screw conveyor a higher rotary frequency is provided than for the filter basket.

Of course it is also possible that the rotary frequency for the filter basket is higher than the rotary frequency for the screw conveyor. Both variants lead to excellent results of the drying for the graded product.

Another aspect of the invention is given by the fact that on the centrifugal press a transmission means is provided which transmits the motion of rotation from the drive to the filter basket and/or the screw conveyor.

As transmission means here, according to a modification of the invention, a belt drive with pulleys is provided for the transmission of the rotation movement of the drive to the screw conveyor and the filter basket. A belt drive has the advantage that, besides a trouble-free transmission of the rotation movement of the drive it is, at the same time, guaranteed that in the case of an overload of, for example, the screw conveyor, the drive is not damaged as the belts may be adjusted in such a way that, for the case of an overload, then the belts will slide on the blocked pulley. Thus neither the drive will be damaged nor the screw conveyor is affected.

Another advantage of the embodiment of the transmission means as belt drive is given by the fact that the pulleys have different diameters for the screw conveyor and for the filter basket. Thus the differing rotary frequencies for the filter basket and the screw conveyor are achieved in a very easy and convenient manner.

The use of toothed belts instead of a V-belt is also provided according to a development of the invention.

Of course it is also possible to provide a gear as transmission means. In order to prevent damages by the possible blockades described above a coupling between the drive and the gear can be engaged which is designed as a sort of friction clutch, and starts sliding when overloaded. Also by means of that the positive effects described above may be achieved. The gear may have, for example different toothed wheels, respectively pinions, which then also are able to transmit a different rotary frequency to screw conveyor and filter basket.

A preferred modification of the invention provides that the transmission means is designed for the transmission of a rotation of 1000 rpm to the filter basket, and a rotation of 1080 rpm to the screw conveyor. This is a preferred modification by means of which optimal results may be achieved.

The screw conveyor is arranged, according to a development of the invention, on a shaft. It is possible here that the screw conveyor and shaft are provided as two components. The screw conveyor may be here also assembled from single segments. Of course, it is also possible to design screw conveyor and shaft as one piece.

It is also preferred if the shaft is designed pipe-like and is connected with the inlet for the graded product. By means of the pipe-like design it is possible to convey the graded product in the interior of the shaft to the initial side of the screw conveyor to an opening to the screw conveyor, and to pressurise it for that purpose, if necessary. The graded product may be transported in the interior of the shaft without any problems to the initial side of the screw conveyor. There it gets to the opening and is, by means of the motion of rotation of the screw conveyor, pressed, respectively flung, to the filter basket, and thus dried. The gradient of the screw conveyor has the effect that the graded product which has to be dried is removed in the direction of the gradient of the screw conveyor to the outlet for the dried product.

The shaft is, according to an embodiment of the invention, orientated essentially vertically, and supported in a top bearing and a bottom bearing.

Another variant of the invention provides that the shaft, the screw conveyor included, is arranged orientated essentially horizontally.

Another embodiment of the centrifugal press according to the invention provides that the shaft is orientated diagonally, preferably at an angle of 45°. Of course, the invention is not restricted to an angle of 45°. Just every other angle position may be used in order, for example, to house the shaft, the screw conveyor included, optimally in a machine housing.

The screw conveyor has, of course, a gradient. The gradient may be provided here in an angle between 2° and 45°. According to a preferred embodiment the gradient is between 3° and 4°.

The direction of conveying of the screw conveyor is preferably the vertical direction from the initial side to the final side of the screw conveyor, respectively to the outlet for the dried product, and, in particular, provided from the bottom to the top. Thus, besides an excellent drying effect, also a removing of the dried graded product is made easier. Of course, the liquid runs, because of the gravity, in vertical direction on the housing wall, respectively in a space between, downward to the drain for this liquid.

A centrifugal press as described before is, according to an advantageous development, characterised by the fact that the centrifugal press is designed in such a way that the graded product is introduced from above, and gets down in the pipe-like designed shaft, is pressed there through an opening in the screw conveyor, and is then, according to the direction of conveying, conveyed to the final side of the screw conveyor, and pressed there by means of the motion of rotation of the screw conveyor simultaneously to the filter basket, and, by means of that, the moisture present in the graded product is pressed through a perforation provided in the filter basket, and gets in the collecting space. Therefore the graded product is pressurised via an inlet for the graded product, and pressed in the shaft which is designed pipe-like in the interior. Because of pressurising it is conveyed preferably downward to the initial side of the screw conveyor. There is an opening which connects the interior of the shaft with the initial side of the screw conveyor. Within the gradient of the screw conveyor and influenced by its rotational motion the graded product is now pressed or flung outward, and pressed against the filter basket. By means of that the graded product is dried, similar to the spin drier, and the liquid may leave via the perforation in the filter basket. Because of the gradient and the rotational motion of the screw conveyor the graded product rises further, and is thus dried additionally. At the end of the screw conveyor the graded product is pressed to the outlet for the dried product, and may there, for example, be let off into a container or a vessel. Between filter basket and housing a space is provided through which the liquid pressed out of the graded product may get downward to a drain for the liquid. This is the collecting space for the liquid of the graded product.

By means of the embodiment according to the invention, as described above, a continuous drying process is carried out in a very effective manner. On the one hand, it is secured that via the inlet for the graded product permanently fresh graded product is introduced. The screw conveyor dries the graded product in interaction with the filter basket by pressing it outward to the filter basket by means of the motion of rotation. Thus the liquid may, as already described, evade in the collecting space, and can be let off permanently from there. The dried graded product rises upward in the screw conveyor, is further dried there permanently, and then disposed of via the outlet for the dried product also permanently.

In order to further improve the self-cleaning process for the centrifugal press according to the invention, on the outer circumference of the screw conveyor bristles are provided which interact with the interior surface of the filter basket for self-cleaning. By means of the permanent rotational motion of the screw conveyor and differing rotary frequencies of the rotational motions of filter basket and screw conveyor thus the region of the perforations of the filter basket is cleaned permanently by the bristles. This is a very effective measurement because sticking mass or smears of the perforations which might be present won't occur anymore.

It has been found here according to the invention that it is in particular advantageous if the bristles are designed in such a way that they regenerate by flowing, respectively transported, fiber material in the graded product. The result is that the bristles are subjected to a permanent self-regeneration, and thus effects of wear are at least reduced, if not prevented altogether.

The perforation of the filter basket in a modification of the invention is characterised by the fact that it corresponds with the separation relation of the graded product, respectively its consistency. Therefore it is, for example, possible, if the graded product, respectively the consistency of the graded product, changes, to use a filter basket with another perforation which is adapted to this consistency of the graded product. However, it is also possible, according to another embodiment of the invention, that the perforation can be adapted to different separation conditions. This may be achieved, for example, by using a filter basket which is designed at least double-layered, and the perforation can be changed by different supports of the two layers of the filter basket. The size of the perforations may be changed, for example, by a relative shifting of the two layers of the filter basket.

The filter basket is, according to a development of the invention, characterised by the fact that it is supported on one side preferably on the bottom in a basket bearing. According to this embodiment the top bearing can be done without completely as a permanent self-adjusting of the filter basket in the top region takes place by the interaction of screw conveyor, respectively its exterior rim with the bristles and the filter basket.

Of course it is also provided that the filter basket is supported on one side in the bottom basket bearing described above, and is, additionally, guided on the top in a guide.

This guide is designed, for example, as slide bearing or guide bush.

According to another modification of the invention it is provided furthermore to arrange the filter basket without separate bearing swinging freely around the screw conveyor.

According to the invention it is also provided that according to another modification of the invention between the exterior wall of the filter basket and the interior wall of the housing a collecting space for separated liquid from the graded product is provided. In this collecting space the liquid may be let off downward because of the gravity, and gets there in a drain for this liquid. There the liquid may disposed of either in a container or directly into the sewage channel. According to that the drain is arranged preferably in the bottom region of the housing.

As the separated liquid still contains parts, and, in particular, very small parts of solid materials, it is preferably provided to arrange, in another modification according to the invention, at least one rinsing rail, for example in the bottom level of the filter basket. In order to be able to rinse away the solid particles deposited there rinsing is performed either continuously or in certain intervals with cleaning liquid, for example with clear water, so that clogging is avoided securely.

### BRIEF DESCRIPTION OF THE DIFFERENT VIEWS OF THE DRAWINGS

The invention is described in the following by means of examples. The single FIGURE shows here an embodiment of a centrifugal press according to the invention.

### DETAILED DESCRIPTION OF THE PREFERRED EMBODIMENT

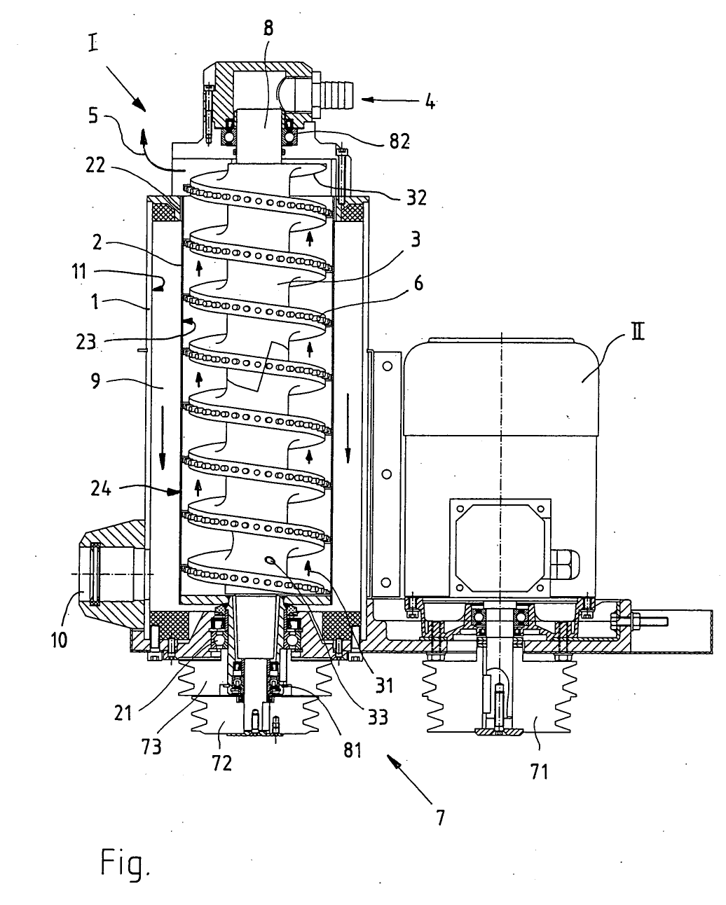

FIG. 1 shows a partial section through an embodiment of the centrifugal press I according to the invention. In the housing 1 a rotatably supported filter basket 2 is provided in which an also rotatably supported screw conveyor 3 is located. The initial side of the screw conveyor is indicated with reference number 31, and the final side of the screw conveyor with the reference number 32. In the screw conveyor 3 there is, in the region of the initial side 31 of the screw conveyor, the opening 33 through which the graded product gets out of the shaft 8 to the initial side 31 of the screw conveyor. The graded product is pressed in the pipe-like shaft 8 via the inlet 4 for the graded product, and gets from there to the opening 33, and is pressed in the screw conveyor 3. The arrows pointing upward in the screw conveyor 3 indicate that the graded product is conveyed upward in the direction of the gradient. As the screw conveyor 3 simultaneously carries out a motion of rotation, the graded product is, of course, pressed from the outside to the filter basket 2, through the perforation of which the liquid present in the graded product gets in the collecting space 9 for the liquid. The collecting space 9 is arranged here between the exterior wall 24 of the filter basket 2 and the interior wall 11 of the housing 1. The arrows in the collecting space 9 indicate the direction of draining of the separated liquid from the graded product in the direction of the outlet 10 for the liquid. The shaft 8 of the screw conveyor 3 is supported in a bottom bearing 81 and in a top bearing 82.

The bearing for the filter basket is located in the bottom part of the device and has the reference number 21. The top guide 22 for the filter basket 2 is designed, for example, as bush, respectively as slide bearing, and is provided in the top part of the housing 1. On the right hand side of the drawing according to FIG. 1 the drive II is indicated schematically. This may be, for example, an electro-motor. The drive II has a pulley 71 which can hold four V-belts. The V-belts are not shown for clearness sakes. The rotation motion of the drive II is transferred from the pulley 71 to the pulley 72 for the screw conveyor 3 and the pulley 73 for the filter basket 2. In the example according to FIG. 1 it is provided that the pulley for the filter basket has a larger diameter than the pulley for the screw conveyor 3. This secures that the filter basket 2 rotates with a lower speed than the screw conveyor 3. Of course also the reversed principle is possible according to which the screw conveyor 3 can move slower than the filter basket 2. The invention is not restricted to either one of the possibilities.

On the final side 32 of the screw conveyor the now dried graded product is conveyed in the outlet 5 for the dried product. From there it may either be filled in containers or vessels so that it may be utilised later. The screw conveyor 3 has a gradient which is in the range of 3° to 4° in the chosen example. This angle may, of course, have other dimensions. The solution according to the invention will also still work in an angle range between 2° and 45°.

On the exterior radius of the screw conveyor 3, respectively the screw conveyor segments, bristles 6 are provided. These bristles 6 serve for self-cleaning the centrifugal press I. By the relative movement between filter basket 2 and screw conveyor 3 caused by differing rotary frequencies of screw conveyor 3 and filter basket 2 the result is that the bristles 6 interact with the interior surface 23 of the filter basket 2 for self-cleaning. The bristles 6 are designed here in such a way that fiber material which flows or is transported in the grade product regenerates them.

The dimensions of the perforation of the filter basket 2 may be adapted in order to adjust the separation relation. The rotational axis of the screw conveyor 3 is arranged vertically according to the presentation in the example of FIG. 1. It may be, however, also at an angle of 45° to the horizontal line or even horizontal. The direction of conveying of the screw conveyor 3 is, as shown in the example, preferably upward. The shaft 8 of the screw conveyor 3 is hollow, that means it is designed pipe-like, and guides the graded product from the inlet 4 for the graded product to the initial side 31 of the screw conveyor and thus to the lowest region of the centrifugal press I. The graded product is then pressed under pressure in the space between the screw conveyor 3 and the interior surface 23 of the filter basket 2. The rotating speeds of the screw conveyor 3 and the filter basket 2 are different, as already mentioned. The different rotational speeds may here be, of course, adapted to the respective graded product, that means the rotational speed of the screw conveyor 3 and the rotational speed of the filter basket 2 are different, and are nevertheless in a high dimension. Very convenient results are received, for example, when the filter basket 2 has a speed of 1000 rotations per minute, and the screw conveyor 1080 rotations per minute.

Because of the stripping of the wing surface of the screw conveyor 3 it may happen that the openings of the perforation in the filter basket 2 get closed by the dried product, that means they may be smeared and clog. In order to avoid that the conveying members of the screw conveyor 3 have bristles on the front surface in order to effect a self-cleaning of the filter basket 2, and thus prevent the openings reliably from clogging.

With the centrifugal press I according to the invention, which actually can be manufactured and used in any dimension, according to a preferred modification with a height of the filter basket of 40 cm and a diameter of 150 mm with the given rotary frequencies a throughput of 30 kg graded product (wet) per minute has been reached. The liquid content of the dried product depends here on several input parameters. On the one hand, of course, on the introduced graded product, on the rotational speed, but also on the passage openings in the filter basket 2. The drive II is effected, for example, by the belt drive already described which might be equipped with V-belts or toothed belts. Of course, also a gear is possible which generates the different rotation relation by means of different transmission relations. Other advantages of the invention are provided by the absolute self-cleaning. Furthermore there is no risk of operators getting hurt as the rotating parts are arranged in the housing. If, for example, an operator puts his hand by mistake in the output region, the hand would be pushed out by the dried graded product without getting hurt.

Although the invention has been described by exact examples which are illustrated in the most extensive detail, it is pointed out that this serves only for illustration, and that the invention is not necessarily limited to it because alternative embodiments and methods become clear for experts in view of the disclosure. Accordingly changes can be considered which can be made without departing from the contents of the described invention.

1. Centrifugal press for drying wet, respectively moist, graded product, comprising a housing in which a filter basket is provided which can be set in a motion of rotation by means of a drive, and an outlet for the liquid leaving the graded product, characterised in that a rotatably supported screw conveyor (3) is arranged in the filter basket (2), and an inlet (4) is provided for the graded product through which the graded product is conveyed between the filter basket (2) and the screw conveyor (3) to an outlet (5) for the dried product.

2. Centrifugal press according to claim 1, characterised in that the drive (II) drives the screw conveyor (3) as well as the filter basket (2), preferably with different rotary frequencies.

3. Centrifugal press according to claim 1, characterised in that the drive (II) drives the screw conveyor (3) as well as the filter basket (2), preferably with different rotary frequencies, and the provided dimension for the differences between the rotary frequencies for the filter basket (2) and the screw conveyor (3) are between 1 and 20 percent, preferably between 6 and 8 percent.

4. Centrifugal press according to claim 1, characterised in that the drive (II) drives the screw conveyor (3) as well as the filter basket (2), preferably with different rotary frequencies, and for the screw conveyor (3) a higher rotary frequency is provided than for the filter basket (2).

5. Centrifugal press according to claim 1, characterised in that the drive (II) drives the screw conveyor (3) as well as the filter basket (2), preferably with different rotary frequencies, and the rotary frequency for the filter basket (2) is higher than the rotary frequency for the screw conveyor (3).

6. Centrifugal press according to claim 1, characterised in that a transmission means (7) is provided which transmits the motion of rotation from the drive (II) to the filter basket (2) and/or the screw conveyor (3).

7. Centrifugal press according to claim 1, characterised in that a transmission means (7) is provided which transmits the motion of rotation from the drive (II) to the filter basket (2) and/or the screw conveyor (3), and as transmission means (7) a belt drive with pulleys (71, 72, 73) is provided for transmitting the rotational motion of the drive (II) to the screw conveyor (3) and the filter basket (2).

8. Centrifugal press according to claim 1, characterised in that a transmission means (7) is provided which transmits the motion of rotation from the drive (II) to the filter basket and/or the screw conveyor (3), and as transmission means (7) a belt drive is provided with pulleys (71, 72, 73) for the rotation motion of the drive (II) to the screw conveyor (3) and the filter basket (2), and the pulley (71) for the screw conveyor (3) and the pulley (73) for the filter basket (2) have different diameters.

9. Centrifugal press according to claim 1, characterised in that a transmission means (7) is provided which transmits the motion of rotation from the drive (II) to the filter basket (2) and/or the screw conveyor (3), and as transmission means (7) a gear is provided.

10. Centrifugal press according to claim 1, characterized in that a transmission means (7) is provided which transmits the motion of rotation from the drive (II) to the filter basket (2) and/or the screw conveyor (3), and the transmission means (7) is designed for the transmission of a rotation of 1000 rpm to the filter basket (2) and a rotation of 1080 rpm to the screw conveyor (3).

11. Centrifugal press according to claim 1, characterised in that the screw conveyor (3) is arranged on a shaft (8), or the screw conveyor (3) and the shaft (8) are designed as one piece.

12. Centrifugal press according to claim 1, characterised in that the screw conveyor (3) is arranged on a shaft (8), or the screw conveyor (3) and the shaft (8) are designed as one piece, and the shaft (8) is designed pipe-like and is connected with the inlet (4) for the graded product.

13. Centrifugal press according to claim 1, characterised in that the screw conveyor (3) is arranged on a shaft (8), or the screw conveyor (3) and the shaft (8) are designed as one piece, and the shaft (8) is designed pipe-like and is connected with the inlet (4) for the graded product, and the graded product in the interior of the shaft (8) can be conveyed to the initial side (31) of the screw conveyor to an outlet (33), and can be pressurised for that purpose.

14. Centrifugal press according to claim 1, characterised in that the screw conveyor (3) is arranged on a shaft (8), or the screw conveyor (3) and the shaft (8) are designed as one piece, and the shaft (8) is orientated essentially vertically and is supported in a bottom bearing (81) and a top bearing (82).

15. Centrifugal press according to claim 1, characterised in that the screw conveyor (3) is arranged on a shaft (8), or the screw conveyor (3) and the shaft (8) are designed as one piece, and the shaft (8) is arranged essentially orientated horizontally.

16. Centrifugal press according to claim 1, characterised in that the screw conveyor (3) is arranged on a shaft (8), or the screw conveyor (3) and the shaft (8) are designed as one piece, and the shaft (8) is orientated diagonally, preferably arranged at an angle of 45°.

17. Centrifugal press according to claim 1, characterised in that the screw conveyor (3) has a gradient with an angle between 2 to 45°.

18. Centrifugal press according to claim 1, characterized in that the direction of conveying of the screw conveyor (3) is provided preferably in vertical direction from an initial side (31) of the screw conveyor to an final side (32) of the screw conveyor, respectively to the outlet (5) for the dried product, from bottom to top.

19. Centrifugal press according to claim 1, characterized in that the screw conveyor (3) is arranged on a shaft (8), or the screw conveyor (3) and the shaft (8) are designed as one piece, and the shaft (8) is designed pipe-like and connected with the inlet (4) for the graded product, and the centrifugal press (I) is designed in such a way that the graded product is supplied from above and gets down in the pipe-like designed shaft (8), is pressed there through an opening (33) in the screw conveyor (3), and then is conveyed according to the direction of conveying of the screw conveyor (3) to the final side (32) of the screw conveyor, and is pressed at the same time by the rotational motion of the screw conveyor (3) to the filter basket (2), and, by means of that, the moisture contained in the graded product is pressed through a perforation provided in the filter basket (2), and gets in a collecting space (9).

20. Centrifugal press according to claim 1, characterised in that on the external circumference of the screw conveyor (3) bristles (6) are provided which interact with an interior surface (23) of the filter basket (2) for self-cleaning.

21. Centrifugal press according to claim 1, characterised in that on the external circumference of the screw conveyor (3) bristles (6) are provided which interact with an interior surface (23) of the filter basket (2) for self-cleaning, and the bristles (6) are designed in such a way that they regenerate themselves by fiber material flowing, respectively being transported, in the graded product.

22. Centrifugal press according to claim 1, characterised in that the filter basket (2) has a perforation which corresponds with the separation relation of the graded product, respectively its consistency.

23. Centrifugal press according to claim 1, characterised in that the filter basket (2) has a perforation which corresponds with the separation relation of the graded product, respectively its consistency, and the perforation can be adapted to different separation relations.

24. Centrifugal press according to claim 1, characterised in that the filter basket (2) is supported on one side in a basket bearing (21) which is provided preferably on the bottom.

25. Centrifugal press according to claim 1, characterised in that the filter basket (2) is supported on one side in a basket bearing (21) which is provided preferably on the bottom, and is guided additionally in a guide (22) on the top.

26. Centrifugal press according to claim 1, characterised in that the filter basket (2) is supported on one side in a basket bearing (21) which is provided preferably on the bottom, and is guided additionally in a guide (22) on the top, and the guide (22) is designed as slide bearing or guide bush.

27. Centrifugal press according to claim 1, characterised in that the filter basket (2) is arranged, without separate bearing, freely swinging around the screw conveyor (3).

28. Centrifugal press according to claim 1, characterised in that the housing (1) has an interior wall (11) and the filter basket (2) has an exterior wall (24), and between the exterior wall (24) of the filter basket (2) and the interior wall (11) of the housing (1) a collecting space (9) for the separated liquid of the graded product is provided.

29. Centrifugal press according to claim 1, characterised in that the housing (1) has an interior wall (11) and the filter basket (2) has an exterior wall (24), and between the exterior wall (24) of the filter basket (2) and the interior wall (11) of the housing (1) a collecting space (9) is provided for the separated liquid of the graded product, and in the collecting space (9) an outlet (10) for the separated liquid is arranged, preferably in the bottom region of the housing (1).

30. Centrifugal press according to claim 1, characterised in that the housing (1) has an interior wall (11) and the filter basket (2) has an exterior wall (24), and between the exterior wall (24) of the filter basket (2) and the interior wall (11) of the housing (1) a collecting space (9) is provided for the separated liquid of the graded product, and in the collecting space (9) at least one rinsing rail is arranged, preferably in the lower level of the filter basket (2).
